(19) United States
(12) Patent Application Publication
(10) Pub. No.: US 2024/0031729 A1
(43) Pub. Date: Jan. 25, 2024

(54) NOISE CANCELLATION ENABLED HEADPHONE

(71) Applicant: ams International AG, JONA (CH)

(72) Inventor: Peter MCCUTCHEON, GORING, Berkshire (GB)

(73) Assignee: ams International AG, JONA (CH)

(21) Appl. No.: 18/256,445

(22) PCT Filed: Nov. 22, 2021
(86) PCT No.: PCT/EP2021/082483

§ 371 Date: Jun. 8, 2023

(30) Foreign Application Priority Data
Dec. 11, 2020 (DE) 10 2020 133 139.8

(51) Int. Cl. H04R 1/10; G10K 11/178

(52) U.S. Cl. CPC H04R 1/1083; H04R 1/1008; G10K 11/17881; G10K 11/17854; G10K 2210/1081; G10K 2210/3027; G10K 2210/3028

(57) ABSTRACT

A noise cancellation enabled headphone to be worn on or over an ear of a user includes a speaker, a feed-forward microphone predominantly sensing ambient sound, an error microphone being arranged in front of the speaker in a primary direction of sound emission of the speaker and adapted to sensing sound being output from the speaker and ambient sound. A baffle is arranged between the speaker and the error microphone in the primary direction of sound emission such that the sound being output from the speaker is delayed by the baffle at a location of the error microphone. An adaptive noise cancellation controller is configured to perform feed-forward noise cancellation based on a feed-forward signal recorded with the feed-forward microphone and filtered with feed-forward filter parameters, and to adjust the feed-forward filter parameters based on an error signal recorded with the error microphone.

### CROSS-REFERENCE TO RELATED APPLICATIONS

The present application is the national stage entry of International Patent Application No. PCT/EP2021/082483, filed on Nov. 22, 2021, and published as WO 2022/122361 A1 on Jun. 16, 2022, which claims priority to German Application No. 10 2020 133 139.8, filed on Dec. 11, 2020, the disclosures of all of which are incorporated by reference herein in their entireties.

### FIELD OF THE INVENTION

The present disclosure provides a noise cancellation enabled headphone to be worn on or over an ear of a user.

### BACKGROUND OF THE INVENTION

Nowadays a significant number of headphones are equipped with noise cancellation techniques. For example, such noise cancellation techniques are referred to as active noise cancellation or ambient noise cancellation, both abbreviated with ANC. ANC generally makes use of recording ambient noise that is processed by filters for generating an anti-noise signal, which is then combined with a useful audio signal to be played over a speaker of the headphone.

Various ANC approaches make use of feedback, FB, microphones, feed-forward, FF, microphones or a combination of feedback and feed-forward microphones. For FF ANC, the feed-forward (FF) microphone is placed on the outside of the headphone, such that it is acoustically decoupled from the headphones driver.

Some noise cancellation headphones are able to perform an adaptation of the filter of the FF ANC based on an error signal recorded by an error microphone placed inside a volume that is directly acoustically coupled to the eardrum, conventionally close to the front of the headphones driver. However, an optimum performance for the adaptation would be achieved at the location of the eardrum being the desired target for the cancellation. Nevertheless, in a real headphone it is not possible to place a microphone inside an ear canal to monitor a signal at the eardrum.

### SUMMARY OF THE INVENTION

The present disclosure provides an improved concept for adaptive noise cancellation in a headphone.

The improved concept relates to an adaptive noise cancellation headphone that can refine an anti-noise signal to compensate for changes in headphone acoustics due to variation in headphone fit and due to manufacturing tolerances. For example, such changes in acoustics of a headphone to be worn on or over an ear of a user can occur if a leakage from the ambient environment to the headphone volume being directly acoustically coupled to the eardrum changes.

Specifically the improved concept is based on the insight that a phase relation between a sound path from the ambient environment to the eardrum and a sound path from the speaker or driver to the eardrum does not match a phase relation between a sound path from the ambient environment to the error microphone and a sound path from the speaker or driver to the error microphone. Hence the improved concept proposes to delay the output signal of the headphone driver relative to the error microphone such that ratios resulting from the signals detected at the error microphone more closely represent those at the eardrum reference point (DRP). The delay is achieved by a baffle placed between the speaker and the error microphone. In short, this allows an adaptive noise cancellation system to more accurately monitor the signals at the eardrum which results in a more accurate adaptation and better noise cancellation.

The improved concept is applicable e.g. to circumaural headphones and/or supra-aural headphones. Circumaural headphones (sometimes called full size headphones or over-ear headphones) have circular or ellipsoid ear pads or ear cushions that encompass the ears. Because these headphones completely surround the ear, circumaural headphones can be designed to seal against the head to attenuate external noise. Supra-aural headphones or on-ear headphones have pads that press against the ears, rather than around them. This type of headphone generally tends to have less attenuation of outside noise.

The FF target of a conventional headphone is commonly understood to be represented by the formula:

$$\frac{AE}{AFFM \cdot DE} ,$$

where AE is the ambient to ear acoustic transfer function, DE is the driver to ear acoustic transfer function and AFFM is the ambient to FF microphone acoustic transfer function. At the error microphone, this becomes:

$$\frac{AErr}{AFFM \cdot DErr} ,$$

where AErr is the ambient to error acoustic transfer function and DErr is the driver to error acoustic transfer function. By analyzing the signal paths on a headphone when there is an acoustic leakage under the ear cushion, it can be seen that the key difference between the two FF targets is that the difference in path length between the AE/DE signals relative to the AErr/DErr signals is significant, leading to a significant phase difference in FF targets. Delaying DErr reduces this difference.

Hence, a noise cancellation enabled headphone to be worn on or over an ear of a user according to the improved concept comprises a speaker, a feed-forward microphone predominantly sensing ambient sound and an error microphone being arranged in front of the speaker in a primary direction of sound emission of the speaker. The error microphone is adapted to sensing sound being output from the speaker and ambient sound. The headphone further comprises a baffle arranged between the speaker and the error microphone in the primary direction of sound emission such that the sound being output from the speaker is delayed by the baffle at a location of the error microphone. The headphone is configured to record a feed-forward signal with the feed-forward microphone and an error signal with the error microphone, and to provide the feed-forward signal and the error signal to an adaptive noise cancellation controller.

The adaptive noise cancellation controller is configured to perform feed-forward noise cancellation based on the feed-forward signal filtered with feed-forward filter parameters. The adaptive noise cancellation controller is further configured to adjust the feed-forward filter parameters based on the error signal recorded with the error microphone.

Accordingly, the baffle fulfils the function of delaying the driver to error acoustic transfer function DErr. Hence the error signal recorded with the error microphone with respect to both ambient sound and the sound being output by the speaker better matches the desired target at the user's eardrum.

In particular, the baffle is arranged such that it does not delay the ambient sound being sensed by the error microphone and entering an air volume between the speaker and an ear of a user at an ear cushion of the headphone. The baffle may further be arranged such that neither sound being output from the speaker nor ambient sound entering the air volume between the speaker and an ear of the user at the ear cushion is delayed on its way to the user's eardrum.

In various implementations of the headphone, the baffle for example increases a sound route or acoustic propagation route, e.g. a propagation time or propagation distance, between the speaker and the error microphone, for example compared to a direct sound route between the speaker and the error microphone without the baffle. Accordingly, the delay of the sound being output from the speaker is achieved by the increased sound route of the acoustic signal.

In various implementations the baffle is acoustically opaque, such that the sound being output from the speaker propagates to the error microphone along the baffle. In other words, to reach the microphone, the sound being output from the speaker cannot go through the baffle but has to propagate around the baffle, e.g. along a surface of the baffle.

In some implementations the baffle is an acoustically translucent baffle or an acoustically resistive baffle, such that the sound being output from the speaker propagates to the error microphone along a path of least resistance determined by an acoustic impedance of the baffle. For example, if the baffle is not completely acoustically opaque, then the delay that the baffle produces will be reduced as the impedance of the baffle material is reduced.

In various implementations the error microphone, respectively an area of sound reception of the error microphone, is located in the center of the headphone. This achieves that a variation in the ambient to error acoustic transfer function AErr is minimized if a leakage under the ear cushion comes from different locations.

For example, an area of sound reception of the error microphone is located generally equidistantly with respect to an ear cushion of the headphone, e.g. a circumferential ear cushion. Generally equidistantly for example means that a variation in the distance to the circumference of the ear cushion is minimized.

For example, the area of sound reception is an opening of a cavity in which the error microphone is enclosed. Hence, all sound going to the error microphone has to go through this area of sound reception such that the actual position of the error microphone within the cavity plays no role or only a minor role with respect to the effective sound route or acoustic propagation route to the error microphone. This particularly is effective with respect to the various positions where ambient sound can enter the air volume between the speaker and the ear of the user at the ear cushion.

In various implementations the baffle at least partially covers an active area of sound emission of the speaker. For example, the baffle covers between 30% and 95% of an active area of sound emission of the speaker, e.g. between 50% and 80%.

In various implementations the baffle is located basically centrally in front of an active area of sound emission of the speaker. In such an implementation the error microphone, or at least the area of sound reception of the error microphone, may be located centrally with respect to the baffle.

In various embodiments the active area of sound emission may simply be determined by the diaphragm of the speaker. However, in some implementations the diaphragm of the speaker may be arranged in a cavity or in a housing of the speaker, wherein an outlet of the cavity or the housing determines the active area of sound emission of the speaker. For example, the outlet of the cavity or the housing couples to an ear-canal volume of the user.

In some implementations the error microphone is also used as a feedback (FB) microphone for performing FB noise cancellation. For example, the adaptive noise cancellation controller is further configured to perform FB noise cancellation based on the error signal recorded with the error microphone and filtered with FB filter parameters.

However, due to the delay introduced by the baffle, the upper bandwidth of the FB noise cancellation may be reduced. This may lead to a reduction of FB noise cancellation performance. This will be tolerable in a number of applications due to the improved feed-forward noise cancellation performance.

However, in some implementations the headphone further comprises a feedback microphone being arranged in proximity to the speaker in the primary direction of sound emission and sensing sound being output from the speaker and ambient sound. The headphone is further configured to record a feedback signal with the FB microphone and to provide the feedback signal to the adaptive noise cancellation controller, which is further configured to perform FB noise cancellation based on the feedback signal recorded with the FB microphone and filtered with FB filter parameters.

Hence, while the presence of the baffle results in a delay for the sound output by the speaker the error microphone, no delay is effected at the position of the FB microphone. Proximity of the FB microphone to the speaker means that at least an area of sound reception of the FB microphone is so close to the speaker, respectively the area of sound emission of the speaker, that little or no delay exists between sound emission and sound reception.

The adaptive noise cancellation controller may be external to the headphone, e.g. within a mobile device, to which the headphone is connected, or may be comprised by the headphone.

In all of the embodiments described above, ANC can be performed both with digital and/or analog filters. All of the audio systems may include feedback ANC as well. Processing and recording of the various signals is preferably performed in the digital domain.

### BRIEF DESCRIPTION OF THE DRAWINGS

The improved concept will be described in more detail in the following with the aid of drawings. Elements having the same or similar function bear the same reference numerals throughout the drawings. Hence their description is not necessarily repeated in following drawings.

In the drawings:

FIG. 1 shows a schematic view of a headphone;

FIG. 2 shows a further schematic view of a headphone;

FIG. 3 shows phase-frequency diagrams associated with a headphone;

FIG. 4 shows a further schematic view of a headphone; and

FIG. 5 shows a further schematic view of a headphone in an elevated view.

### DETAILED DESCRIPTION

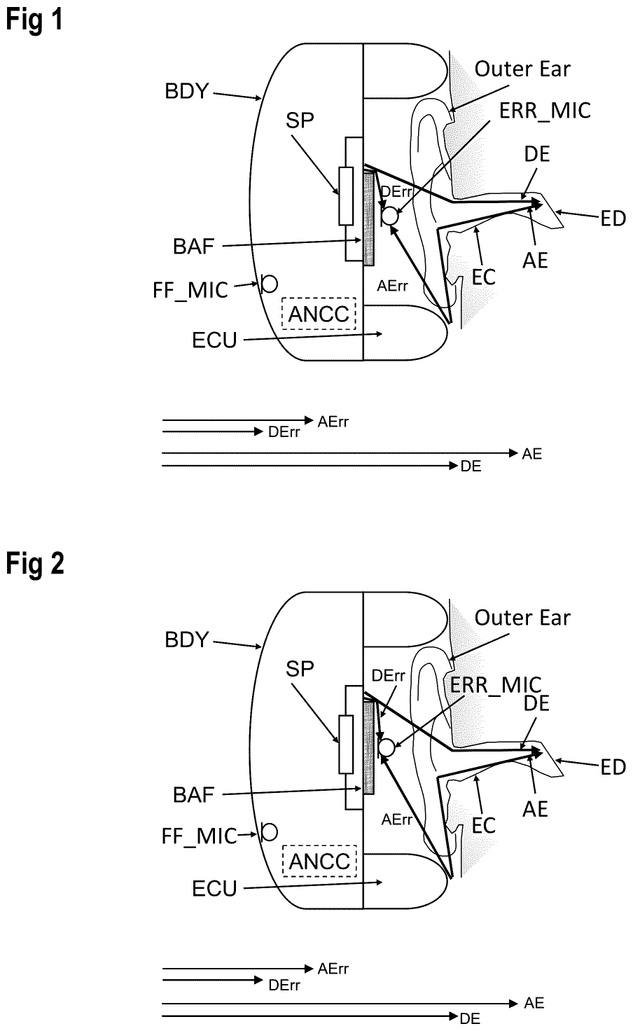

FIG. 1 shows a schematic view of an implementation of a headphone according to the improved concept, wherein the headphone is worn over a user's ear. In this example implementation, the headphone is implemented as a circumaural headphone with a headphone body BDY having a basically circumferential cushion ECU that basically seals a volume of air between an inner portion of the headphone and a user's ear. As will be explained in more detail below, a seal between the headphone, respectively the cushion ECU, and the user's head may vary, e.g. due to movements of the user or the headphone, varying shapes of different users wearing the headphone or manufacturing tolerances.

The headphone comprises a speaker SP that is shown schematically only with an indication of a coil and an area of sound emission of the speaker SP, e.g. a diaphragm or an opening or housing of the speaker SP, in which the diaphragm is arranged.

The headphone is equipped as a noise cancellation enabled headphone and cooperates with an adaptive noise cancellation controller ANCC and a feed-forward microphone FF_MIC predominantly sensing ambient sound. To this end, the feed-forward microphone FF_MIC is placed in the body BDY facing away from the headphone, respectively towards any ambient sounds. The adaptive noise cancellation controller ANCC is configured to perform feed-forward noise cancellation based on a feed-forward signal recorded with the feed-forward microphone FF_MIC and filtered with feed-forward filter parameters. As is well known in the art, the filtered signal is output via the speaker SP to cancel out or at least compensate for ambient sounds reaching the user's ear with an anti-noise signal. In the present example, the adaptive noise cancellation controller ANCC is comprised by the headphone. However, in other implementations, the adaptive noise cancellation controller ANCC may be external to the headphone, e.g. within a mobile device, to which the headphone is connected.

The feed-forward noise cancellation works by matching an electronic filter, defined by the feed-forward filter parameters, to an acoustic target response that compensates principally for the headphone's passive attenuation and the speaker response.

With changing conditions, in particular changing seal conditions, this target response changes such that it becomes desirable to adjust the feed-forward filter parameters to account for the changed conditions. To this end, the headphone comprises an error microphone ERR_MIC that is arranged in front of the speaker SP in a primary direction of sound emission of the speaker. As can be seen in the drawing, this means that the error microphone ERR_MIC is placed somewhere between the speaker and the user's ear being formed by the outer ear, an ear channel EC and the eardrum ED that defines the drum reference point (DRP). The error microphone ERR_MIC is adapted to sense sound being output from the speaker and ambient sound. An error signal recorded with the error microphone ERR_MIC is used for adjusting the feed-forward filter parameters.

The FF target of a conventional headphone is commonly understood to be represented by the formula:

$$\frac{AE}{AFFM \cdot DE} ,$$

where AE is the ambient to ear acoustic transfer function between an ambient sound source and the user's eardrum ED, DE is the driver to ear acoustic transfer function between the speaker SP and the user's eardrum ED, and AFFM is the ambient to FF microphone acoustic transfer function between the ambient sound source and the FF microphone FF_MIC.

At the error microphone ERR_MIC, this becomes:

$$\frac{AErr}{AFFM \cdot DErr} ,$$

where AErr is the ambient to error acoustic transfer function between the ambient sound source and the error microphone ERR_MIC, and DErr is the driver to error acoustic transfer function between the speaker SP and the error microphone ERR_MIC.

By analyzing the signal paths in a conventional headphone when there is an acoustic leakage under the ear cushion, it can be seen that the key difference between the two FF targets is that the difference in path length between the AE/DE signals relative to the AErr/DErr signals is significant, leading to a significant phase difference in FF targets.

However, the headphone according to the improved concept further comprises a baffle BAF arranged between the speaker SP and the error microphone ERR_MIC in the primary direction of sound emission, such that the sound being output from the speaker SP is delayed by the baffle BAF at a location of the error microphone ERR_MIC.

While in conventional headphones, where such baffle BAF is not present, a sound path from the speaker to the error microphone is quite short, the sound path from the speaker SP to the error microphone ERR_MIC with the baffle BAF is longer, thereby decreasing the phase difference between AErr and DErr, such that it better matches the ideal conditions at the eardrum ED between AE and DE.

While the sound of the speaker is delayed by the baffle at the location of the error microphone ERR_MIC, the baffle BAF preferably does not delay the ambient sound being sensed by the error microphone ERR_MIC that has entered the air volume between the speaker SP and the ear of the user at the ear cushion ECU.

Accordingly, the baffle BAF may increase the sound route or acoustic propagation route between the speaker SP and the error microphone ERR_MIC, in particular compared to a direct sound route or acoustic propagation route between the speaker SP and the error microphone ERR_MIC without the baffle BAF being present. The exact implementation of the mounting of the error microphone ERR_MIC is not shown in the schematic view used here. However, the position of the error microphone ERR_MIC shown in FIG. 1, for example, resembles an area of sound reception of the error microphone ERR_MIC, i.e. an area through which any sound reaching the error microphone ERR_MIC needs to pass. For example, the error microphone ERR_MIC is mounted in a housing provided with the headphone body BDY or in a cavity of defined depth, wherein an opening of the cavity is the area of sound reception of the error microphone ERR_MIC.

As can be seen in FIG. 1, the area of sound reception of the error microphone ERR_MIC is located generally equidistantly with respect to the ear cushion ECU of the headphone. Generally equidistantly in this context means that a position is chosen that is located basically centrally within the circumference of the ear cushion ECU. Apparently such a center position depends on the form and/or construction of the ear cushion ECU. The generally centralized position achieves that more or less independently of an exact position of leakage between the ear cushion ECU and the user's head and/or ear, ambient sound entering the air volume inside the ear cushion ECU has a comparable sound route or acoustic propagation route to the error microphone ERR_MIC.

The positioning of the error microphone ERR_MIC can also consider a likelihood of positions where ambient sound enters the air volume inside the ear cushion ECU under leaky conditions. For example, if it is more likely that ambient sound enters the air volume inside the ear cushion ECU from the bottom side, as is shown in FIG. 1, this can be accounted for in the positioning of the error microphone ERR_MIC.

In various implementations, the baffle BAF at least partially covers an active area of sound emission of the speaker SP, as is shown in the implementation of FIG. 1. For example, the baffle covers between 30% and 95% of an active area of sound emission of the speaker, e.g. between 50% and 80%. As mentioned above, a diaphragm of the speaker may be arranged in a cavity or a housing of the speaker SP, wherein an outlet of the cavity or the housing determines the active area of sound emission of the speaker SP.

Referring now to FIG. 2, a further example implementation of the noise cancellation enabled headphone is shown that is based on the implementation of FIG. 1. While in FIG. 1 the baffle BAF is arranged non-centrically before the speaker SP, the baffle BAF in the implementation of FIG. 2 is located basically centrally in front of an active area of sound emission of the speaker SP.

For example, if the error microphone ERR_MIC is mounted centrally, then the central baffle mounting may be better as with one side open the driver signal from the speaker SP already follows the path of least resistance, so opening the other side will not make the delay any shorter but will improve the driver-to-ear response DE. If the baffle BAF is mounted as in FIG. 1, the more delay can be extracted by moving the error microphone ERR_MIC to the edge, however, the driver-to-ear response DE will be worse. So there is a trade-off between driver-to-ear quality, driver-to-error delay and robustness to leakages entering from different directions, and baffle placement will vary depending on which is the priority.

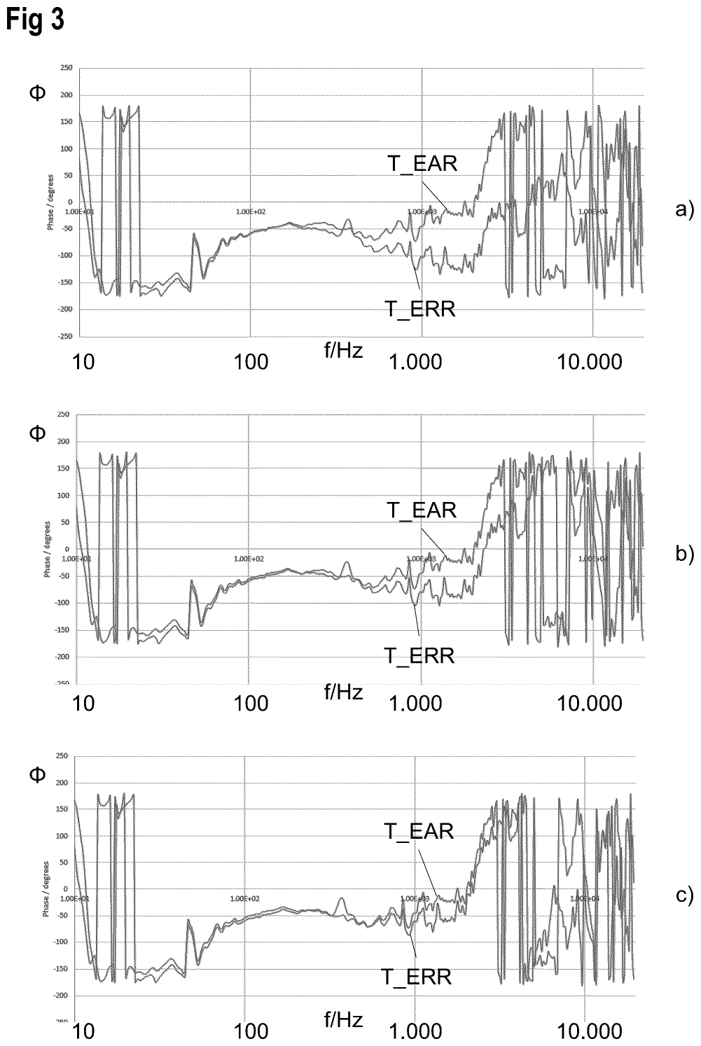

Referring now to FIG. 3, several phase frequency diagrams are shown, each visualizing a frequency-dependent phase of a target response TEAR at the eardrum and a target response T_ERR at the error microphone ERR_MIC. The target response TEAR at the eardrum ED, that resembles the ideal transfer function for minimizing ambient noise at the eardrum ED, is the same for all three diagrams a), b) and c). In all three diagrams, it is assumed that there is a small leak under the ear cushion ECU, as shown in FIG. 1 and FIG. 2.

The upper diagram a) of FIG. 3 corresponds to the target phase response T_ERR without any delay through a baffle BAF present between the speaker SP and the error microphone ERR_MIC, i.e. as in a conventional headphone. It can be seen that particularly in the frequency range between 200 Hz and 3000 Hz there is a high deviation between the ideal target response TEAR and the actual target response T_ERR, resulting in suboptimal ambient noise cancellation.

In the middle diagram b) of FIG. 3, the driver to error microphone ERR_MIC response DErr is delayed by 20 mm, respectively approximately two-fifths of the diameter of the area of sound emission of the speaker SP, the diameter being approximately 50 mm in these examples. As can be seen from the phase diagram, the deviation of the target response T_ERR is reduced significantly compared to the undelayed case without a baffle BAF. Hence, the noise cancellation performance and/or adaptation performance is increased.

The bottom diagram c) of FIG. 3 shows the target phase response T_ERR with a baffle present delaying the driver to error microphone ERR_MIC response DErr by 40 mm, respectively approximately four-fifths of the diameter of the active area of sound emission of the speaker SP. It can be seen that a deviation between the ideal target response TEAR and the actual response T_ERR is further reduced such that noise cancellation performance and/or adaptation performance is further increased.

Referring back to FIG. 1 and FIG. 2, the baffle BAF may be acoustically opaque such that the sound being output from the speaker SP propagates to the error microphone ERR_MIC along the baffle BAF. This is particularly based on the assumption that an acoustically opaque baffle prevents sound going through the baffle itself.

In various other implementations the baffle BAF may be an acoustically translucent baffle or an acoustically resistive baffle, which do not fully block sound going through the baffle but provide an acoustic resistance still contributing to a delay of the respective sound. This effects that the sound being output from the speaker SP propagates to the error microphone ERR_MIC along a path of least resistance determined by an acoustic impedance of the baffle BAF. For example, if the baffle is not completely acoustically opaque, then the delay that the baffle produces will be reduced as the impedance of the material of the baffle is reduced.

The arrangement of the headphone in FIG. 1 and FIG. 2 also allows the adaptive noise cancellation controller ANCC to further perform FB noise cancellation. In particular, to this end the error signal recorded with the error microphone ERR_MIC is filtered with feedback filter parameters to contribute to the anti-noise signal output via the speaker. However, due the delay introduced by the baffle BAF with respect to the error microphone's ERR_MIC location, FB noise cancellation performance may be reduced.

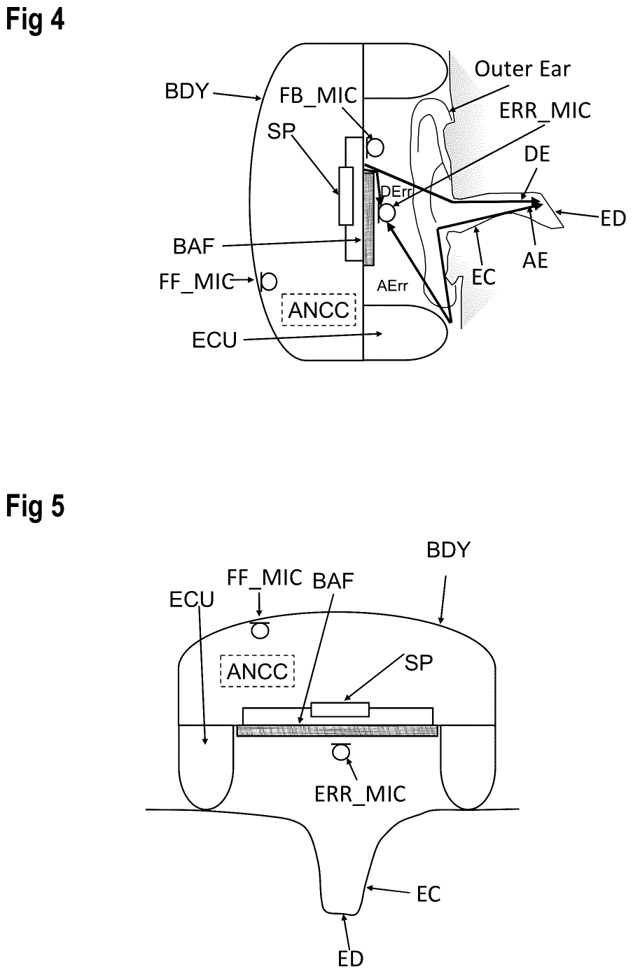

Referring now to FIG. 4, this can be accounted for by further introducing a dedicated FB microphone FB_MIC that is arranged in proximity to the speaker SP in the primary direction of sound emission. The FB microphone FB_MIC therefore senses sound being output from the speaker SP and ambient sound, e.g. entering the air volume inside the headphone between the ear cushions ECU and the user's head and/or ear. Besides the additional FB microphone FB_MIC the headphone of FIG. 4 basically corresponds to that of FIG. 1. The adaptive noise cancellation controller ANCC in the implementation of FIG. 4 is further configured to perform FB noise cancellation based on a feedback signal recorded with the FB microphone FB_MIC and filtered with feedback filter parameters.

Referring now to FIG. 5, an elevated view of a headphone according to one of the described implementations is shown. In particular, FIG. 5 shows the headphone viewed from the top of the head of a user, compared to the side view in FIG. 1, FIG. 2 and FIG. 4. FIG. 5 shows one possible implementation of dimensions of the baffle BAF, e.g. covering the full length of the speaker respectively its area of sound emission in this dimension. Other ratios of covering are not excluded, as discussed above.

While in the shown implementations of the headphone, the headphone is depicted as an over-ear headphone or circumaural headphone, the improved concept employing the baffle BAF can also be used with the headphone being implemented as an on-ear headphone or supra-aural headphone, in particular where ear cushions provide a seal between an air volume between the headphone's speaker and the user's ear.

If the baffle BAF covers the speaker SP, at least partially, this may affect the speaker driver's response. To this end, different distancing of the baffle BAF from the speaker or the area of sound emission of the speaker SP can be considered. Furthermore, as mentioned above, using for example an acoustically resistive baffle instead of a completely acoustically opaque baffle can also be considered.

Furthermore, the baffle BAF in front of the speaker SP may reduce room in a front air volume for the pinna. To this end, the speaker may be moved back a little to increase the room. However, it will be appreciated that there are many alternative arrangements for the error microphone ERR_MIC, speaker SP and baffle BAF that all delay the sound being output from the speaker at the location of the error microphone ERR_MIC.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the spirit of the appended claims. The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

1. A noise cancellation enabled headphone to be worn on or over an ear of a user, the headphone comprising
a speaker;
a feed-forward microphone predominantly sensing ambient sound;
an error microphone being arranged in front of the speaker in a primary direction of sound emission of the speaker and adapted to sensing sound being output from the speaker and ambient sound; and
a baffle arranged between the speaker and the error microphone in the primary direction of sound emission such that the sound being output from the speaker is delayed by the baffle at a location of the error microphone;
wherein the headphone is configured to record a feed-forward signal with the feed-forward microphone and an error signal with the error microphone, and to provide the feed-forward signal and the error signal to an adaptive noise cancellation controller being configured to perform feed-forward noise cancellation based on the feed-forward signal filtered with feed-forward filter parameters and to adjust the feed-forward filter parameters based on the error signal.

2. The headphone according to claim 1, wherein the baffle does not delay the ambient sound being sensed by the error microphone and entering an air volume between the speaker and an ear of a user at an ear cushion of the headphone.

3. The headphone according to claim 1, wherein the baffle increases a sound route between the speaker and the error microphone, in particular compared to a direct sound route between the speaker and the error microphone without the baffle.

4. The headphone according to claim 1, wherein the baffle is acoustically opaque, such that the sound being output from the speaker propagates to the error microphone along the baffle.

5. The headphone according to claim 1, wherein the baffle is an acoustically translucent baffle or an acoustically resistive baffle, such that the sound being output from the speaker propagates to the error microphone along a path of least resistance determined by an acoustic impedance of the baffle.

6. The headphone according to claim 1, wherein an area of sound reception of the error microphone is located generally equidistantly with respect to an ear cushion of the headphone, in particular a circumferential ear cushion.

7. The headphone according to claim 6, wherein the area of sound reception is an opening of a cavity, in which the error microphone is enclosed.

8. The headphone according to claim 1, wherein the headphone is implemented as a circumaural headphone.

9. The headphone according to claim 1, wherein the baffle at least partially covers an active area of sound emission of the speaker.

10. The headphone according to claim 1, wherein the baffle covers between 30% and 95% of an active area of sound emission of the speaker, in particular between 50% and 80%.

11. The headphone according to claim 1, wherein the baffle is located basically centrally in front of an active area of sound emission of the speaker.

12. The headphone according to claim 9, wherein a diaphragm of the speaker is arranged in a cavity or a housing of the speaker, and wherein an outlet of the cavity or the housing determines the active area of sound emission of the speaker.

13. The headphone according to claim 1, wherein the adaptive noise cancellation controller is further configured to perform feedback noise cancellation based on the error signal filtered with feedback filter parameters.

14. The headphone according to claim 1, further comprising a feedback microphone being arranged in proximity to the speaker in the primary direction of sound emission and sensing sound being output from the speaker and ambient sound, wherein the headphone is further configured to record a feedback signal with the feedback microphone and to provide the feedback signal to the adaptive noise cancellation controller, which is further configured to perform feedback noise cancellation based on the feedback signal filtered with feedback filter parameters.

15. The headphone according to claim 1, further comprising the adaptive noise cancellation controller.
